(19) United States
(12) Patent Application Publication
(10) Pub. No.: US 2006/0026371 A1
(43) Pub. Date: Feb. 2, 2006

(54) Method and apparatus for implementing memory order models with order vectors

(76) Inventors: George Z. Chrysos, Milford, MA (US); Ugonna C. Echeruo, Worcester, MA (US); Chyi-Chang Miao, Sharon, MA (US); James R. Vash, North Grafton, MA (US)

Correspondence Address: TROP PRUNER & HU, PC, 8554 KATY FREEWAY, SUITE 100, HOUSTON, TX, 77024, US

(21) Appl. No.: 10/903,675

(22) Filed: Jul. 30, 2004

(51) Int. Cl. G06F 12/00

(52) U.S. Cl. 711/158

(57) ABSTRACT

In one embodiment of the present invention, a method includes generating a first order vector corresponding to a first entry in an operation order queue that corresponds to a first memory operation, and preventing a subsequent memory operation from completing until the first memory operation completes. In such a method, the operation order queue may be a load queue or a store queue, for example. Similarly, an order vector may be generated for an entry of a first operation order queue based on entries in a second operation order queue. Further, such an entry may include a field to identify an entry in the second operation order queue. A merge buffer may be coupled to the first operation order queue and produce a signal when all prior writes become visible.

### BACKGROUND

The present invention relates to memory ordering, and more particularly to processing of memory operations according to a memory order model.

Memory instruction processing must act in accordance with a target instruction set architecture (ISA) memory order model. For reference, Intel Corporation's two main ISAs: Intel® architecture (IA-32 or x86) and Intel's ITANIUM processor family (IPF) have very different memory order models. In IA-32, load and store operations must be visible in program order. In the IPF architecture, they do not in general, but there are special instructions by which a programmer can enforce ordering when necessary (e.g., load acquire (referred to herein as “load acquire”), store release (referred to herein as “store release”), memory fence, and semaphores).

One simple, but low-performance strategy for keeping memory operations in order is to not allow a memory instruction to access a memory hierarchy until a prior memory instruction has obtained its data (for a load) or gotten confirmation of ownership via a cache coherence protocol (for a store).

However, software applications increasingly rely upon ordered memory operations, that is, memory operations which impose an ordering of other memory operations and themselves. While executing parallel threads in a chip multiprocessor (CMP), ordered memory instructions are used in synchronization and communication between different software threads or processes of a single application. Transaction processing and managed run-time environments rely on ordered memory instructions to function effectively. Further, binary translators that translate from a stronger memory order model ISA (e.g., x86) to a weaker memory order ISA (e.g., IPF) assume that the application being translated relies on the ordering enforced by the stronger memory order model. Thus when the binaries are translated, they must replace loads and stores with ordered loads and stores to guarantee program correctness.

With increasing utilization of ordered memory operations, the performance of ordered memory operations is becoming more important. In current x86 processors, processing ordered memory operations out-of-order is already crucial to performance, as all memory operations are ordered operations. Out-of-order processors implementing a strong memory order model can speculatively execute loads out-of-order, and then check to ensure that no ordering violation has occurred before committing the load instruction to machine state. This can be done by tracking executed, but not yet committed load addresses in a load queue, and monitoring writes by other central processing units (CPUs) or cache coherent agents. If another CPU writes to the same address as a load in the load queue, the CPU can trap or replay the matching load (and eradicate all subsequent non-committed loads), and then re-execute that load and all subsequent loads, ensuring that no younger load is satisfied before an older load.

In-order CPU's however can commit load instructions before they have returned their data into the register file. In such a CPU, loads can commit as soon as they have passed all their fault checks (e.g., data translation buffer (DTB) miss, and unaligned access), and before data is retrieved. Once load instructions retire, they cannot be re-executed. Therefore, it is not an option to trap and refetch or re-execute loads after they have retired based upon monitoring writes from other CPUs as described above.

A need thus exists to improve performance of ordered memory operations, particularly in a processor with a weak memory order model.

### BRIEF DESCRIPTION OF THE DRAWINGS

FIG. 1 is a block diagram of a portion of a system in accordance with one embodiment of the present invention.

FIG. 2 is a flow diagram of a method of processing a load instruction in accordance with one embodiment of the present invention.

FIG. 3 is a flow diagram of a method of loading data in accordance with one embodiment of the present invention.

FIG. 4 is a flow diagram of a method of processing a store instruction in accordance with one embodiment of the present invention.

FIG. 5 is a flow diagram of a method of processing a memory fence in accordance with one embodiment of the present invention.

FIG. 6 is a block diagram of a system in accordance with one embodiment of the present invention.

### DETAILED DESCRIPTION

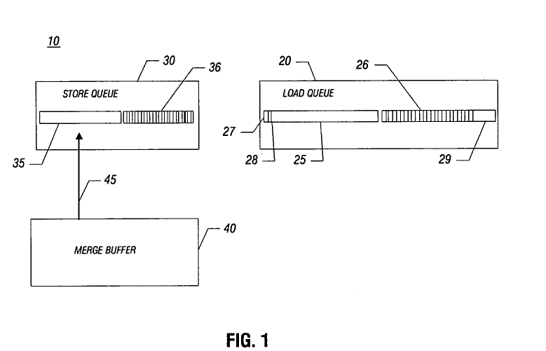

Referring to FIG. 1, shown is a block diagram of a portion of a system in accordance with one embodiment of the present invention. More specifically, as shown in FIG. 1, system 10 may be an information handling system, such as a personal computer (e.g., a desktop computer, notebook computer, server computer or the like). As shown in FIG. 1, system 10 may include various processor resources, such as a load queue 20, a store queue 30 and a merge (i.e., a write combining) buffer 40. In certain embodiments, these queues and buffer may be within a processor of the system, such as a central processing unit (CPU). For example, in certain embodiments such a CPU may be in accordance with an IA-32 or an IPF architecture, although the scope of the present invention is not so limited. In other embodiments, load queue 20 and store queue 30 may be combined into a single buffer.

A processor including such processor resources may use them as temporary storage for various memory operations that may be executed within the system. For example, load queue 20 may be used to temporarily store entries of particular memory operations, such as load operations and to track prior loads or other memory operations that must be completed before the given memory operation itself can be completed. Similarly, store queue 30 may be used to store memory operations, for example, store operations and to track prior memory operations (usually loads) that must be completed before a given memory operation itself can commit. In various embodiments, a merge buffer 40 may be used as a buffer to temporarily store data corresponding to a memory operation until such time as the memory operation (e.g., a store or sempahore) can be completed or committed.

An ISA with a weak memory order model (such as IPF processors) may include explicit instructions that require stringent memory ordering (e.g., load acquire, store release, memory fence, and semaphores), while most regular loads and stores do not impose stringent memory ordering. In an ISA having a strong memory order model (e.g., an IA-32 ISA), every load or store instruction may follow stringent memory ordering rules. Thus a program translated from an IA-32 environment to an IPF environment, for example, may impose strong memory ordering to ensure proper program behavior by substituting all loads with load acquires and all stores with store releases.

When a processor in accordance with an embodiment of the present invention processes a load acquire, it ensures that the load acquire has achieved global visibility before subsequent loads and stores are processed. Thus, if the load acquire misses in a first level data cache, subsequent loads may be prohibited from updating the register file, even if they would have hit in the data cache, and subsequent stores must test for ownership of the block they are writing only after the load acquire has returned its data to the register file. To accomplish this, the processor may force all loads younger than an outstanding load acquire to miss in the data cache and enter a load queue, i.e., a miss request queue (MRQ), to ensure proper ordering.

When a processor in accordance with an embodiment of the present invention processes a store release, it ensures that all prior loads and stores have achieved global visibility. Thus, before the store release can make its write globally visible, all prior loads must have returned data to the register file, and all prior stores must have achieved ownership visibility via a cache coherence protocol.

Memory fence and semaphore operations have elements of both load acquire and store release semantics.

Still referring to FIG. 1, load queue 20 (also referred to herein as “MRQ 20”) is shown to include a MRQ entry 25, which is an entry corresponding to a particular memory operation (i.e., a load). While shown as including a single entry 25 for purposes of illustration, multiple such entries may be present. Associated with MRQ entry 25 is an order vector 26 that is formed with a plurality of bits. Each of the bits of order vector 26 may correspond to an entry within load queue 20 to indicate whether prior memory operations have been completed. Thus order vector 26 may track prior loads that are to be completed before an associated memory operation can complete.

Also associated with MRQ entry 25 is an order bit (O-bit) 27 that may be used to indicate that succeeding memory operations stored in load queue 20 should be ordered with respect to MRQ entry 25. Furthermore, a valid bit 28 may also be present. As still further shown in FIG. 1, MRQ entry 25 may also include an order store buffer identifier (ID) 29 that may be used to identify an entry in a store buffer corresponding to the memory operation of the MRQ entry.

Similarly, store queue 30 (also referred to herein as “STB 30”) may include a plurality of entries. For purposes of illustration, only a single STB entry 35 is shown in FIG. 1. STB entry 35 may correspond to a given memory operation (i.e., a store). As shown in FIG. 1, STB entry 35 may have an order vector 36 associated therewith. Such an order vector may indicate the relative ordering of the memory operation corresponding to STB entry 35 with respect to previous memory operations within load queue 20, and in some embodiments, optionally store queue 30. Thus order vector 36 may track prior memory operations (usually loads) in MRQ 20 that must complete before an associated memory operation can commit. While not shown in FIG. 1, in certain embodiments, STB 30 may provide a STB commit notification (e.g., to the MRQ) to indicate that a prior memory operation (usually a store in the STB) has now committed.

In various embodiments, merge buffer 40 may transmit a signal 45 (i.e., an “All Prior Writes Visible” signal) that may be used to indicate that all prior write operations have achieved visibility. In such an embodiment, signal 45 may be used to notify that a release-semantic memory operation in STB 30 (usually a store release, memory fence or semaphore release) that has delayed committing may now commit upon receipt of signal 45. Use of signal 45 will be discussed further below.

Together, these mechanisms may enforce memory ordering as needed by the semantics of the memory operations issued. The mechanisms may facilitate high performance, as a processor in accordance with certain embodiments may only enforce ordering constraints when desired to take advantage of native binaries that use a weak memory order model.

Further, in various embodiments, order vector checks for loads may be deferred as late as possible. This has two implications. First, with respect to pipelined memory accesses, loads that require ordering constraints access the cache hierarchy normally (aside from being forced to miss the primary data cache). This allows a load to access second and third level caches and other processor socket caches and memory before its ordering constraints are checked. Only when the load data is about to write into the register file is the order vector checked to ensure that all constraints are met. If a load acquire misses the primary data cache, for example, a subsequent load (which must wait for the load acquire to complete) may launch its request in the shadow of the load acquire. If the load acquire returns data before the subsequent load returns data, the subsequent load suffers no performance penalty due to the ordering constraint. Thus in the best case, ordering can be enforced while load operations are completely pipelined.

Second, with respect to data prefetching, if a subsequent load tries to return data before a preceding load acquire, it will have effectively prefetched its accessed block into the CPU cache. After the load acquire returns data, the subsequent load may retry out of the load queue and get its data from the cache. Ordering may be maintained because an intervening globally visible write causes the cache line to be invalidated, resulting in the cache block being refetched to obtain an updated copy.

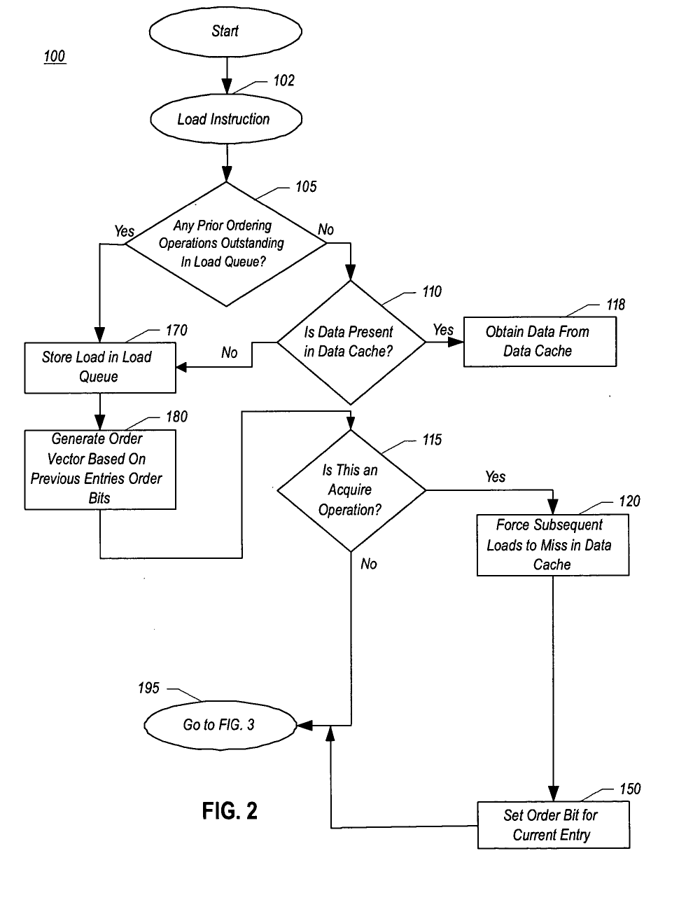

Referring now to FIG. 2, shown is a flow diagram of a method of processing a load instruction in accordance with one embodiment of the present invention. Such a load instruction may be a load or a load acquire instruction. As shown in FIG. 2, method 100 may begin by receiving a load instruction (oval 102). Such an instruction may be executed in a processor with memory ordering rules in which a load acquire instruction becomes globally visible before any subsequent load or store operations become globally visible. Alternately, a load instruction need not be ordered in certain processor environments. While the method of FIG. 2 may be used to handle load instructions, a similar flow may be used in other embodiments to handle other memory operations which conform to memory ordering rules of other processors in which a first memory operation must become visible prior to subsequent memory operations.

Still referring to FIG. 2, next, it may be determined whether any prior ordered operations are outstanding in a load queue (diamond 105). Such operations may include load acquire instructions, memory fences, and the like. If such operations are outstanding, the load may be stored in a load queue (block 170). Further, an order vector corresponding to the entry in the load queue may be generated based on previous entries' order bits (block 180). That is, order bits in the generated order vector may be present for orderable operations such as load acquires, memory fences and the like. In one embodiment, the MRQ entry may copy the O-bits of all previous MRQ entries to generate its order vector. For example, if five previous MRQ entries are present, each of which has yet to become globally visible, the order vector for the sixth entry may include a one value for each of the five previous MRQ entries. Then, control may pass to diamond 115, as will be discussed further below. While FIG. 2 shows that a current entry may be dependent on prior ordering operations in the store queue, the current entry may also be dependent on prior ordering operations in the store queue and accordingly, it may also be determined whether there are any such operations in the store queue.

If instead at diamond 105, it is determined that no prior ordered operations are outstanding in the load queue, it may be determined whether data is present in a data cache (diamond 110). If so, the data may be obtained from the data cache (block 118) and normal processing may continue.

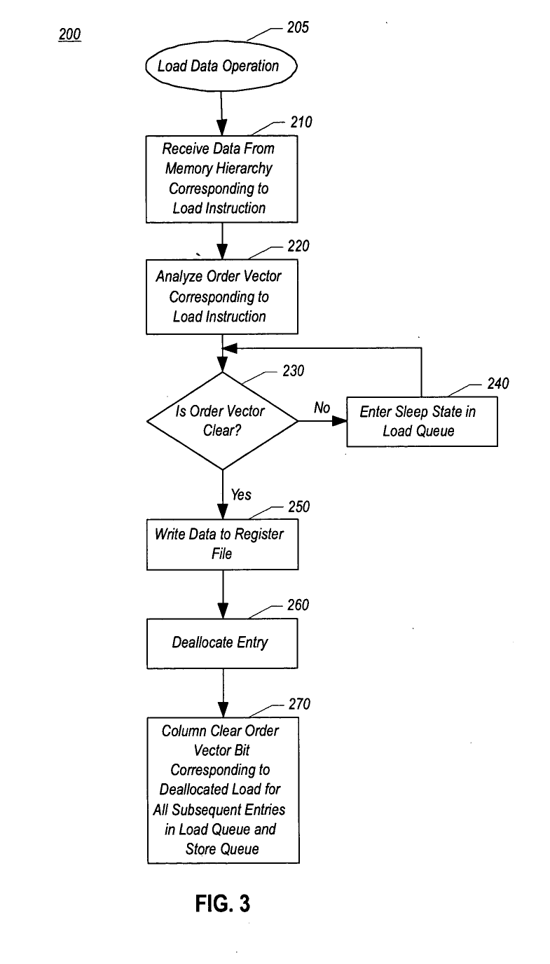

At diamond 115, it may be determined whether the instruction is a load acquire operation. If it is not, control may pass to FIG. 3 for obtaining the data (oval 195). If instead at diamond 115 it is determined that the instruction is a load acquire operation, control may pass to block 120, where subsequent loads may be forced to miss in the data cache (block 120). Then, the MRQ entry when generated may also set its own O-bit (block 150). Such an order bit may be used by subsequent MRQ entries to determine how to set their order vector with respect to the currently existing MRQ entries. In other words, a subsequent load may notice an MRQ entry's O-bit by setting a corresponding bit in its order vector accordingly. Next, control may pass to oval 195, which corresponds to FIG. 3, discussed below.

While not shown in FIG. 2, in certain embodiments, subsequent load instructions may be stored in an MRQ entry and generate an O-bit and an order vector corresponding thereto. That is, subsequent loads may determine how to set their order vector by copying the O-bits of existing MRQ entries (i.e., a subsequent load will notice the load acquire's O-bit by setting the corresponding bit in its MRQ entry's order vector). While not shown in FIG. 2, it is to be understood that subsequent (i.e., non-release) stores may determine how to set their order vector the same way loads do, based on MRQ entries' O-bits.

Referring now to FIG. 3, shown is a flow diagram of a method of loading data in accordance with one embodiment of the present invention. As shown in FIG. 3, method 200 may begin with a load data operation (oval 205). Next, data may be received from the memory hierarchy corresponding to the load instruction (block 210). Such data may reside in various locations of a memory hierarchy, such as system memory or a cache associated therewith, or an on or off-chip cache associated with a processor. When the data is received from the memory hierarchy, it may be stored in data cache, or other temporary storage location.

Then, an order vector corresponding to the load instruction may be analyzed (block 220). For example, an MRQ entry in a load queue corresponding to the load instruction may have an order vector associated therewith. The order vector may be analyzed to determine whether the order vector is clear (diamond 230). In the embodiment of FIG. 3, if all the bits of the order vector are clear, this may indicate that all prior memory operations have been completed. If the order vector is not clear, this indicates that such prior operations have not been completed and accordingly, the data is not returned. Instead, the load operation goes to sleep in the load queue (block 240), awaiting progress from prior memory operations, such as previous load acquire operations.

If instead the order vector is determined to be clear at diamond 230, control may pass to block 250 in which the data may be written to a register file. Next, the entry corresponding to the load instruction may be deallocated (block 260). Finally, at block 270, the order bit corresponding to the completed (i.e., deallocated) load operation may be column cleared from all subsequent entries in the load queue and store queue. In such manner, these order vectors may be updated with the completed status of the current operation.

If a store operation is about to attempt to attain global visibility (e.g., copy out from the store buffer to the merge buffer, and request ownership for its cache block), it may first check to ensure that its order vector is clear. If it is not, the operation may be deferred until the order vector is completely clear.

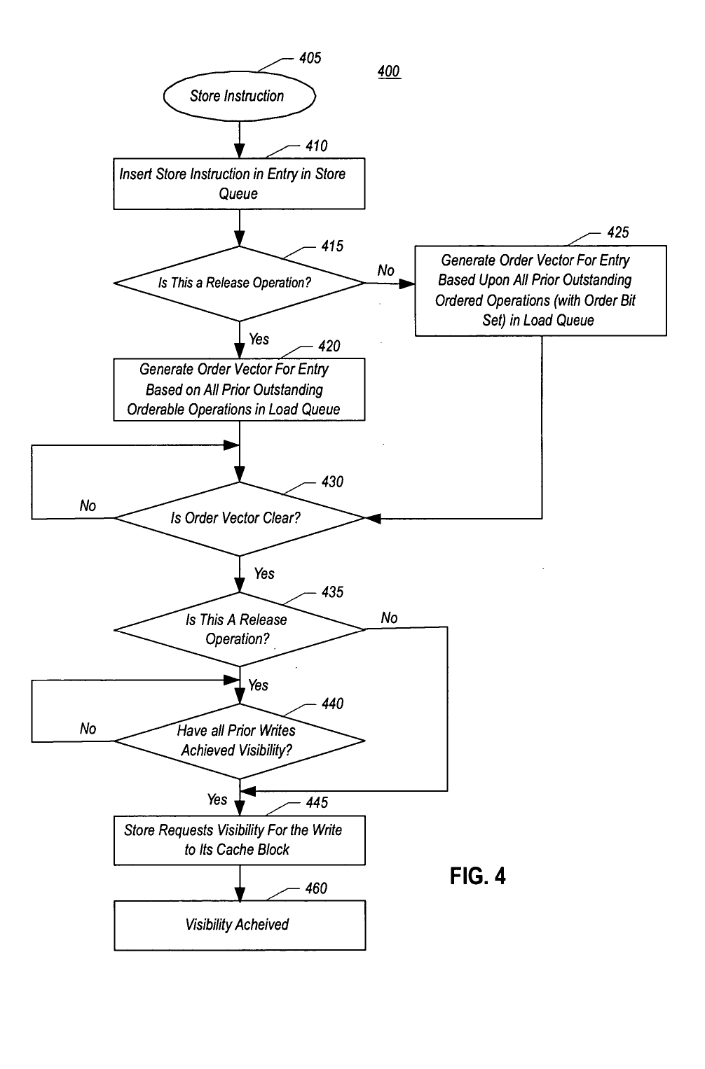

Referring now to FIG. 4, shown is a flow diagram of a method of processing a store instruction in accordance with one embodiment of the present invention. Such a store instruction may be a store or a store release instruction. In certain embodiments, a store instruction need not be ordered. However, in embodiments for use in certain processors, memory ordering rules may dictate that all prior load or store operations become globally visible before a store release operation becomes globally visible itself. While discussed in the embodiment of FIG. 4 as relating to store instructions, it is to be understood that such a flow or a similar flow may be used to process similar memory ordering operations that require prior memory operations to become visible prior to visibility of the given operation.

Still referring to FIG. 4, method 400 may begin by receiving a store instruction (oval 405). At block 410 the store instruction may be inserted into an entry in the store queue. Next, it may be determined whether the operation is a store release operation (diamond 415). If it is not, an order vector may be generated for the entry based on all prior outstanding ordered operations in the load queue (with their order bit set) (block 425). Because the store instruction is not an ordered instruction, such order vector may be generated without its order bit set. Then control may pass to diamond 430, as will be discussed further below.

If instead at diamond 415 it is determined that a store release operation is present, next, an order vector for the entry may be generated based on information regarding all prior outstanding orderable operations in the load queue (block 420). As discussed above, such an order vector may include bits corresponding to pending memory operations (e.g., outstanding loads in an MRQ, as well as memory fences and other such operations).

At diamond 430, it may be determined whether the order vector is clear. If the order vector is not clear, a loop may be executed until the order vector becomes clear. When the order vector does become clear, it may be determined whether the operation is a release operation (diamond 435). If it is not, control may pass directly to block 445, as discussed below. If instead it is determined that a release operation is present, it may then be determined whether all prior writes have achieved visibility (diamond 440). For example, in one embodiment stores may be visible when data corresponding to the instruction is present in a given buffer or other storage location. If not, diamond 440 may loop back upon itself until all the prior writes have achieved visibility. When such visibility is achieved, control may pass to block 445.

There, the store may request visibility for the write to its cache block (block 445). While not shown in FIG. 4, data may be stored in the merge buffer at the time that the store is allowed to request visibility. In one embodiment, if all prior stores have attained visibility, a merge buffer visibility signal may be asserted. Such a signal may indicate that all prior store operations have attained global visibility, as confirmed by the merge buffer. In one embodiment, a cache coherency protocol may be queried in order to attain such visibility. Such visibility may be attained when the cache coherency protocol provides an acknowledgment back to the store buffer.

In certain embodiments, a cache block for a store release operation may already be in the merge buffer (MGB), owned, when the store release is ready to attain visibility. The MGB may maintain high performance for streams of store releases (e.g., in code segments where all stores are store releases), if there is a reasonable amount of merging in the MGB for these blocks.

If the store has attained visibility, an acknowledgement bit may be set for store data in the merge buffer. The MGB may include this acknowledgment bit, also referred to as an ownership or dirty bit, for each valid cache block. In such embodiments, the MGB may then perform an OR operation across all of its valid entries. If any valid entries are not acknowledged, the “all prior writes visible” signal may be deasserted. Once this acknowledgement bit is set, the entry may become globally visible. In such manner, visibility may be achieved for the store or store release instruction (block 460). It is to be understood that at least certain actions set forth in FIG. 4 may be performed in another order in different embodiments. For example, in one embodiment prior writes may be visible when data corresponding to the instruction is present in a given buffer or other storage location.

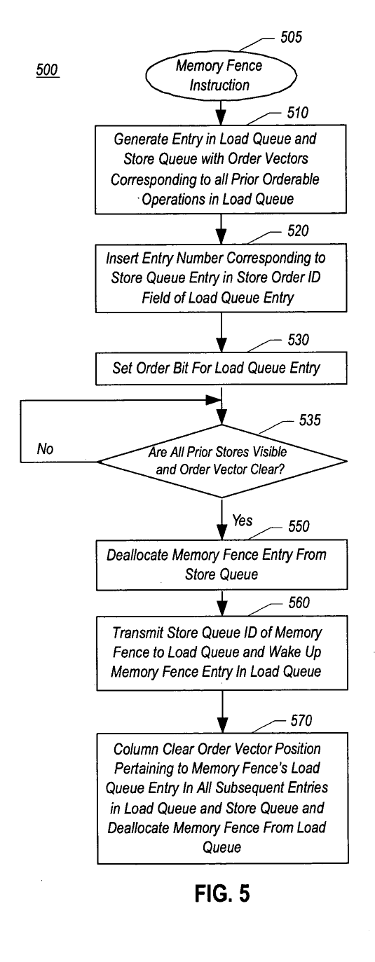

Referring now to FIG. 5, shown is a flow diagram of a method of processing a memory fence (MF) operation in accordance with one embodiment of the present invention. In the embodiment of FIG. 5, a memory fence may be processed in a processor having memory ordering rules which dictate that for a memory fence all prior loads and stores become visible before any subsequent loads and stores can be made visible. In one embodiment, such a processor may be an IPF processor, an IA-32 processor or another such processor.

As shown in FIG. 5, a memory fence instruction may be issued by a processor (oval 505). Next, an entry may be generated in both a load queue and a store queue with order vectors corresponding to the entry (block 510). More specifically, the order vectors may correspond to all prior operable operations in the load queue. In forming the MRQ entry, an entry number corresponding to the store queue entry may be inserted in a store order identification (ID) field of the load queue entry (block 520). Specifically, the MRQ may record the STB entry that was occupied by the memory fence in an “Order STB ID” field. Next, the order bit for the load queue entry may be set (block 530). The MRQ entry for the memory fence may set its O-bit so that subsequent loads and stores register the memory fence in their order vector.

Then it may be determined whether all prior stores are visible and whether the order vector for the entry in the store queue is now clear (diamond 535). If not, a loop may be executed until such stores have become visible and the order vector clears. When this occurs, control may pass to block 550 where the memory fence entry may be deallocated from the store queue.

As in store release processing, the STB may prevent the MF from deallocating until its order vector is clear and it receives an “all prior writes visible” signal from the merge buffer. Once the memory fence deallocates from the STB, the store order queue ID of the memory fence may be transmitted to the load queue (block 560). Accordingly, the load queue may see the store queue ID of the deallocated store, and perform a content addressable memory (CAM) operation across all entries' order store queue ID fields. Further, the memory fence entry in the load queue may be awoken from a sleep state.

Then, the order bit corresponding to the load and queue entries may be column cleared from all other entries (i.e., subsequent loads and stores) in the load queue and store queue (block 570), allowing them to complete, and the memory fence may be deallocated from the load queue.

Ordering hardware in accordance with an embodiment of the present invention may also control the order of memory or other processor operations for other reasons. For example, it can be used to order a load with a prior store that can provide some, but not all, of the load's data (partial hit); it can be used to enforce read-after-write (RAW), write-after-read (WAR), and write-after-write (WAW) data dependency hazards through memory; and it can be used to prevent local bypassing of data from certain operations to others (e.g., from a semaphore to a load, or from a store to a semaphore). Further, in certain embodiments semaphores may use the same hardware to enforce proper ordering.

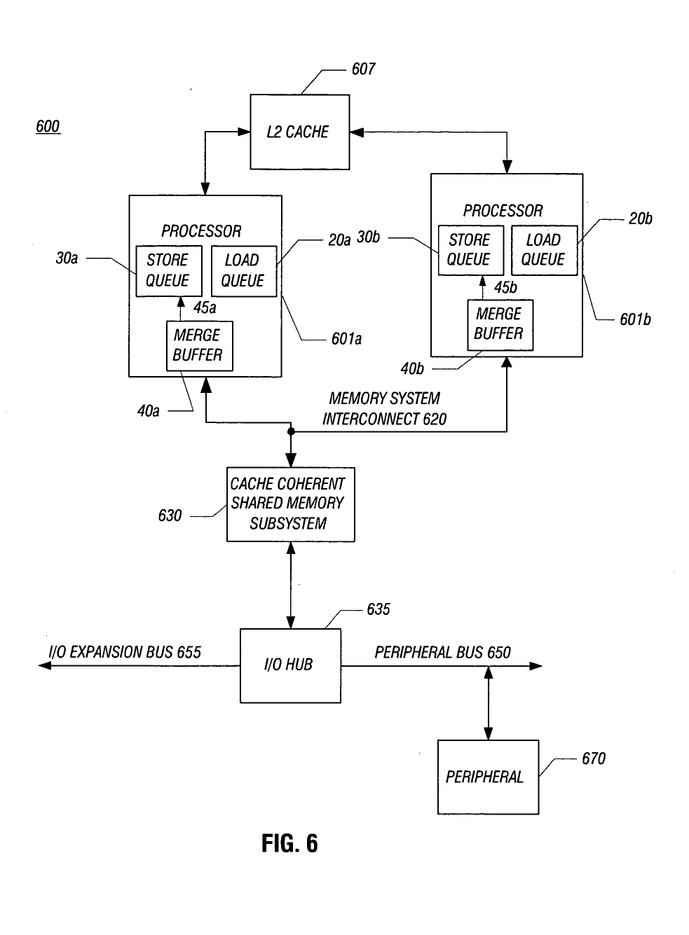

Referring now to FIG. 6, shown is a block diagram of a representative computer system 600 in accordance with one embodiment of the invention. As shown in FIG. 6, computer system 600 includes a processor 601a. Processor 601a may be coupled over a memory system interconnect 620 to a cache coherent shared memory subsystem (“coherent memory 630”) 630 in one embodiment. In one embodiment, coherent memory 630 may include a dynamic random access memory (DRAM) and may further include coherent memory controller logic to share coherent memory 630 between processor 601a and 601b.

It is to be understood that in other embodiments additional such processors may be coupled to coherent memory 630. Furthermore in certain embodiments, coherent memory 630 may be implemented in parts and spread out such that a subset of processors within system 600 communicate to some portions to coherent memory 630 and other processors communicate to other portions of coherent memory 630.

As shown in FIG. 6, processor 601a may include a store queue 30a, a load queue 20a, and a merge buffer 40a in accordance with an embodiment of the present invention. Also, shown is a visibility signal 45a that may be provided to store queue 30a from merge buffer 40a, in certain embodiments. More so, a level 2 (L2) cache 607 may be coupled to processor 601a. As further shown in FIG. 6, similar processor components may be present in processor 601b, which may be a second core processor of a multiprocessor system.

Coherent memory 630 may also be coupled (via a hub link) to an input/output (I/O) hub 635 that is coupled to an I/O expansion bus 655 and a peripheral bus 650. In various embodiments, I/O expansion bus 655 may be coupled to various I/O devices such as a keyboard and mouse, among other devices. Peripheral bus 650 may be coupled to various components such as peripheral device 670 which may be a memory device such as a flash memory, add-in card, and the like. Although the description makes reference to specific components of system 600, numerous modifications of the illustrated embodiments may be possible.

Embodiments may be implemented in a computer program that may be stored on a storage medium having instructions to program a computer system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
generating an order vector associated with an entry in an operation order queue, the entry corresponding to an operation of a system; and
preventing processing of the operation based on the order vector.

2. The method of claim 1, wherein the order vector comprises a plurality of bits each corresponding to an associated entry in the operation order queue.

3. The method of claim 2, further comprising preventing the processing based on bits in the order vector indicative of uncompleted prior operations.

4. The method of claim 2, further comprising clearing a given bit of the order vector when a corresponding prior operation has completed.

5. The method of claim 1, wherein the order vector comprises an order bit associated with each entry in the operation order queue.

6. The method of claim 5, further comprising setting the order bit for entries in the operation order queue corresponding to acquire-semantic memory operations.

7. The method of claim 5, wherein generating the order vector comprises copying the order bits corresponding to prior outstanding prior memory operations into the order vector.

8. The method of claim 1, further comprising forcing a subsequent memory operation to miss in a data cache.

9. The method of claim 1, further comprising setting a first order bit corresponding to the operation.

10. The method of claim 9, further comprising clearing the first order bit when the operation is completed.

11. The method of claim 9, further comprising generating a second order vector corresponding to a subsequent operation, the second order vector including the first order bit.

12. A method comprising:
generating an order vector associated with an entry in a first operation order queue, the entry corresponding to a memory operation, the order vector having a plurality of bits each corresponding to an entry in a second operation order queue; and
preventing processing of the memory operation based on the order vector.

13. The method of claim 12, further comprising preventing the processing based upon bits in the order vector indicative of uncompleted prior memory operations in the second operation order queue.

14. The method of claim 13, further comprising clearing a given bit of the order vector when a corresponding prior memory operation is completed.

15. The method of claim 12, wherein the first operation order queue comprises a store queue, and the second operation order queue comprises a load queue.

16. The method of claim 15, wherein the order vector comprises an order bit associated with each entry in the load queue.

17. The method of claim 16, further comprising setting the order bit for entries in the load queue corresponding to acquire-semantic operations.

18. An article comprising a machine-accessible storage medium containing instructions that if executed enable a system to:
prevent a memory operation from occurring at a first time if an order vector corresponding to the memory operation indicates that at least one prior memory operation has not completed.

19. The article of claim 18, further comprising instructions that if executed enable the system to update the order vector upon completion of the at least one prior memory operation.

20. The article of claim 18, further comprising instructions that if executed enable the system to force subsequent memory operations to miss in a cache.

21. The article of claim 18, further comprising instructions that if executed enable the system to set an order bit for the memory operation.

22. An apparatus comprising:
a first buffer to store a plurality of entries each corresponding to a memory operation, each of the plurality of entries having an order vector associated therewith to indicate relative ordering of the corresponding memory operation.

23. The apparatus of claim 22, further including a second buffer to store a plurality of entries each corresponding to a memory operation, each of the plurality of entries having an order vector associated therewith to indicate relative ordering of the corresponding memory operation.

24. The apparatus of claim 22, further including a merge buffer coupled to the first buffer to produce a signal if prior memory operations are visible.

25. The apparatus of claim 22, wherein each of the plurality of entries comprises an order bit to indicate whether subsequent memory operations are to be ordered with respect to the corresponding memory operation.

26. A system comprising:
a processor having a first buffer to store a plurality of entries each corresponding to a memory operation, each of the plurality of entries having an order vector associated therewith to indicate relative ordering of the corresponding memory operation; and
a dynamic random access memory coupled to the processor.

27. The system of claim 26, further comprising a second buffer to store a plurality of entries each corresponding to a memory operation, each of the plurality of entries having an order vector associated therewith to indicate relative ordering of the corresponding memory operation.

28. The system of claim 26, further comprising a merge buffer coupled to the first buffer to produce a signal if prior memory operations are visible.

29. The system of claim 26, wherein the processor has an instruction set architecture to process load instructions in an unordered fashion.

30. The system of claim 26, wherein the processor has an instruction set architecture to process store instructions in an unordered fashion.
